(19) United States
(12) Patent Application Publication
(10) Pub. No.: US 2005/0049836 A1
(43) Pub. Date: Mar. 3, 2005

(54) METHOD OF DEFECT ROOT CAUSE ANALYSIS

(76) Inventor: Long-Hui Lin, Hsin-Chu Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/708,943

(22) Filed: Apr. 2, 2004

(30) Foreign Application Priority Data
Sep. 3, 2003 (TW) 092124393

(51) Int. Cl. G06F 15/00

(52) U.S. Cl. 702/185

(57) ABSTRACT

A method of defect root cause analysis. First, a sample with a plurality defects thereon is provided. Then, a defect inspection is performed to detect the sizes and positions of the defects. After that, a chemical state analysis is performed, and a mapping analysis is made according to a result of the chemical state analysis. Thus, a root cause of defects can be obtained according to a result of the mapping analysis.

### BACKGROUND OF INVENTION

1. Field of the Invention

The present invention relates to a method of defect root cause analysis, and more particularly, to a method of defect root cause analysis applied to large size wafers.

2. Description of the Prior Art

In the semiconductor fabricating process, some small particles and defects are unavoidable. As the size of devices shrinks and the integration of circuits increases gradually, those small particles or defects affect the property of the integrated circuits more seriously. For improving the reliability of semiconductor devices, a plurality of defect detection are performed continuously, and the detected defects are further examined for analyzing a root cause of the defects. According to the result of the defect root cause analysis, process parameters are tuned correspondingly to reduce a presence of defects or particles so as to improve the yield and reliability of the semiconductor fabricating process.

Please refer to FIG. 1, which is a schematic diagram of a conventional semiconductor fabricating process. As shown in FIG. 1, a plurality of fabricating processes are required for fabricating a semiconductor wafer. Typically, thousands of fabricating processes are carried out in a wafer fab. For clarity, only several fabricating processes are illustrated in FIG. 1 for describing the method of defect control in the prior art. As shown in FIG. 1, a process A 10, a process B 20, a process C 30, a process D 40, and a process E 50 represent five semiconductor fabricating processes which can be performed by a single machine or different machines. The defect detection 60 and 70 sample from the semiconductor wafers that have just experienced the process A 10 and the process C 30, respectively.

Once some excursion cases are found in the defect detection 60 or 70, an advanced defect root cause analysis is performed to find out the root cause of the defects. According to the result of the defect root cause analysis, the process parameters can be tuned properly to reduce the generation of defects caused by the same reason. In the conventional defect root cause analysis, a step by step check focusing on the defect source is performed to attempt to find out in which process the defects are generated. For example, if there are a plurality of adding defects, which are not found in the defect detection 60, detected in the defect detection 70, a step by step check is performed to focus on each process between the defect detection 60 and the defect detection 70. In other words, an examination is performed for the process B 20 and the process C 30 respectively. For example, if no defect is found after finishing the process B 20 but some defects are found after finishing the process C 30, the process C 30 is judged as the source process of the defects. Thus, engineers will try to tune the process parameters of the process C 30 for reducing the defect generation.

Besides a disadvantage of the long response time caused by the step by step check, the conventional defect root cause analysis also has a serious problem of the blind spot. In the prior art, the process in which the defects occur can be found indeed. However, the root cause of the defects may not exist in that process. It is very possible that a process has some small defects or particles which have no effect on the process its own but has a serious influence on a latter process. For example, it is assumed that the process B 20 is an etching process and the process C 30 is a deposition process. For the process B 20, since some little residual impurities or particles on the semiconductor wafer surface has no influence on the process B 20, they are often neglected in the defect detection for the process B. However, while the process C 30 is performed, all the little impurities or particles will grow due to the deposition process and cause the defect generation in the process C 30. In this case, since there is no defect detected in the process B 20 but some defects detected in the process C 30, the conventional method of defect root cause will make a wrong judgment and attempt to reduce the defects by changing the process parameters of the process C 30. However, no matter how the process parameters of the process C 30 are tuned, it just leads to a waste of time and effort since the root cause of the defects occurs in the process B 20.

In addition, in the conventional method of defect root cause analysis, an energy dispersive spectrometer (EDS) is often utilized to perform a chemical state analysis. In the chemical state analysis, electron beams are used to strike a specific location on the surface of the testing object. Then, the chemical elements in this specific location can be obtained according to the characteristic of an X-ray excited by the strike of the electron beams. Thus, by comparing data in a location of a defect with that in the background, the chemical component of the defects can be obtained. This is a significant data for an experienced engineer to judge the root cause of a defect. However, the EDS has a disadvantage of low resolution, low quantitative determination, and insensitivity to the light elements. Thus, it can be only applied to the analysis of large defects instead of that of small defects, which are less than 0.2 μm. As the process size shrinks gradually, the ratio of small defects increases at the same time and the usage of the EDS are reduced thereby.

Furthermore, due to the progression of the semiconductor technology and some economic considerations, the size of wafers increases from 8 inches to 12 inches and the line width reduces from 0.18 μm to 0.13 μm and even below 0.1 μm. In the process from testing into mass production, it is obvious that the fabricating processes have to be changed or tuned significantly. Thus, a quick and sensitive method of defect root cause analysis is strongly required to solve the aforementioned problems.

### SUMMARY OF INVENTION

It is therefore a primary objective of the claimed invention to provide a method of defect root cause analysis which can perform a chemical state analysis of small defects to solve the aforementioned problems in the prior art.

In a preferred embodiment of the claimed invention, a method of defect root cause analysis is disclosed. First, a sample with a plurality defects thereon is provided. Then, a defect inspection is performed to detect the sizes and positions of the defects. After that, a chemical state analysis is performed, and a mapping analysis is made according to a result of the chemical state analysis. Thus, a root cause of defects can be obtained according to a result of the mapping analysis.

It is an advantage that the claimed invention uses a chemical state analysis to obtain the materials of the defects and then judges the defect root cause according to the result of the chemical state analysis. This reduces the judging time of the defect root cause analysis and further improves the sensitivity of the defect root cause analysis significantly, thereby improving yield and reliability of products.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a schematic diagram of a method of defect root cause analysis in the prior art.

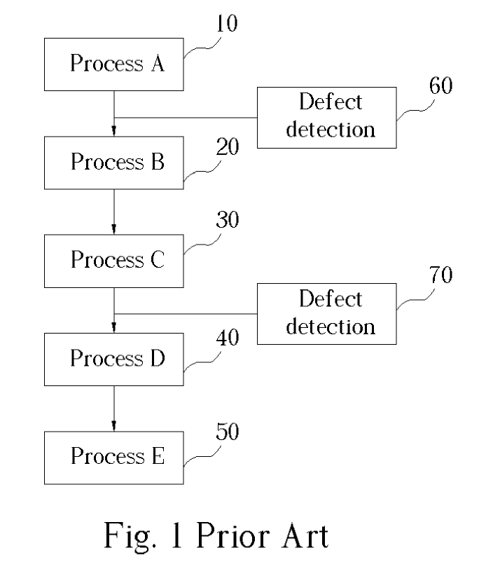

FIG. 2 is a schematic diagram of a method of defect root cause analysis in the present invention.

FIG. 3 is a schematic diagram of a method of defect root cause analysis according to a first embodiment of the present invention.

FIG. 4 is a schematic diagram of a mapping analysis in the first embodiment of the present invention.

FIG. 5 is a schematic diagram of a method of defect root cause analysis according to a second embodiment of the present invention.

FIG. 6 is a schematic diagram of a mapping analysis in the second embodiment of the present invention.

### DETAILED DESCRIPTION

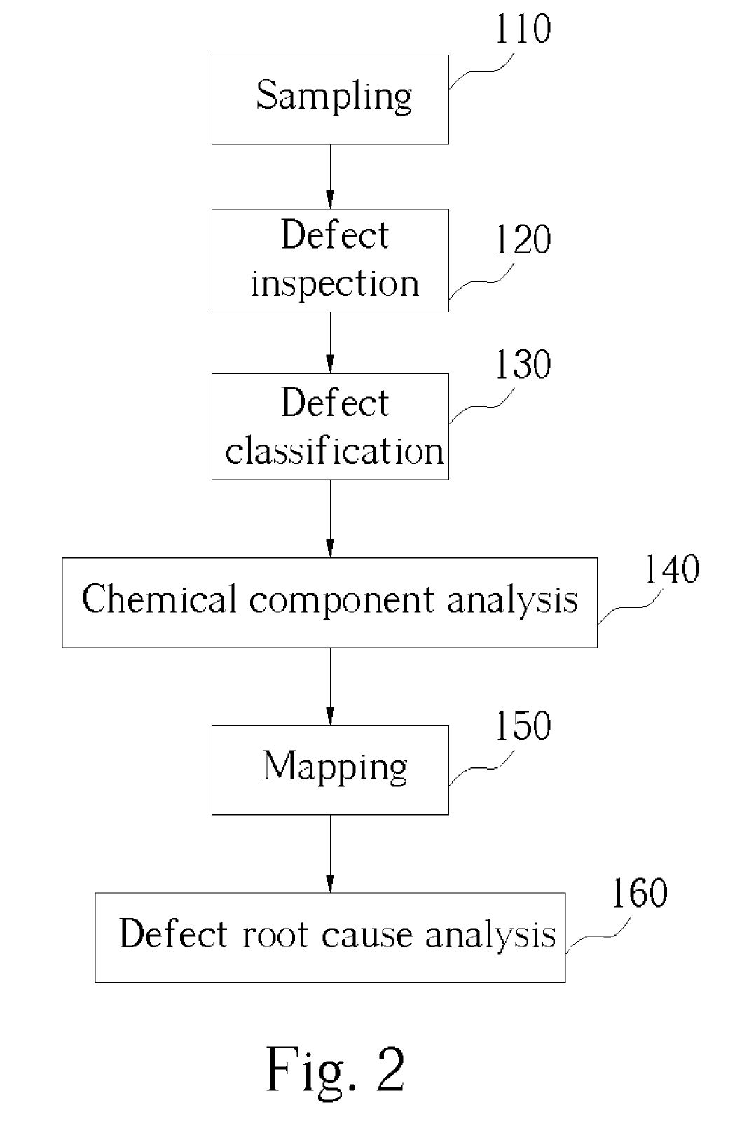

Please refer to FIG. 2, which is a schematic diagram of a method of defect root cause analysis 100 of the present invention. As shown in FIG. 2, a sampling 110 is first performed to obtain a test sample. Then, a defect inspection 120 is performed for the test sample to detect the defects on the test sample. According to a result of the defect inspection 120, a defect classification 130 is performed to separate the detected defects into a plurality of defect types. After that, a proper machine/method is used to perform a chemical state analysis 140 according to the defect types.

In a preferred embodiment of the present invention, the defects on the test sample are divided into three defect types according to their sizes and locations and three methods are used to perform the chemical state analysis 140 corresponding to each defect type respectively. A first defect type includes the defects mainly located on an underlayer of the test sample. A second defect type includes the defects located on the surface of the test sample and are equal to or larger than 0.2 μm, single phase, or thick particles. A third defect type includes the defects located on the surface of the test sample and are smaller than 0.2 μm, not single phase, or not thick particles.

For the second and third defect types, since the defects are mainly located on the surface of the test sample, they can be examined directly by proper machines. Typically, for the second defect type, which is equal to or larger than 0.2 μm, single phase, or thick particles, the EDS, which can only perform a large scale examination, is utilized to perform the chemical state analysis 140. For the third defect types, which are normally smaller particles, a scanning auger microscopy (SAM) or an auger electron spectroscopy (AES) is utilized to perform an auger analysis. By comparing the components of a normal location (background) with those of an excursion location, the component of defects can be obtained. In comparison with the EDS, the auger analysis can only detect for a small scale less than 0.1 μm and a shallow region of about 50 angstroms, but have a higher sensitivity than the EDS, leading to a great examination result for some small and complex structures.

For the first defect type, since the defects of the first defect type are mainly located on the underlayer of the test sample, the chemical state analysis cannot be performed directly. A voltage contrast is often performed first to find a rough location of defects. Then, some proper tools, such as a focus ion beam (FIB), are used to cut the test sample to expose the defects. After that, the chemical state analysis 140 can be performed for the cross-section of the test sample by a method mentioned above, such as an auger analysis.

For all defect types, different analysis methods are used in the chemical state analysis 140 according to the state of the test sample. For example, the chemical state analysis typically includes a point scan analysis, delayer analysis, and depth profile analysis. Then, results of those analyses are concluded together for a mapping analysis 150. Since the shapes, locations, and component of the defect are already known, the root cause of the defects can be analyzed easily by a skilled engineer in most cases. Then, some corresponding actions, such as correcting the fabricating processes, can be taken properly to reduce the defect generation and solve the problem of the excursion cases, improving the reliability of products.

To describe the method of the present invention in detail, two embodiments are provided in following. An analysis according to the conventional method is also provided as a contrast to show the differences between the method of the present invention and that in the prior art. First, a common etching process is illustrated in the first embodiment of the present invention to describe the method of defect root cause analysis in the present invention. For example, it is supposed that we want to form a patterned tungsten (W) conductive line on a silicon oxide layer, but the W conductive line shorts, which is treated as a defect, after the etching process. By using the conventional method of defect root cause analysis, a short loop inspection plan must be set up to trace 3 to 5 processes before the process in which defects are detected and a step by step check is performed to find out the exact process in which the defects occurs. For example, if the defects are only found after the etching process, it is obvious that the defect source is indicated to a wet cleaning process in the last step according to the conventional method of defect root cause analysis. Though the EDS can be also used to assist the defect root analysis, the EDS only can show that the normal region and the excursion region are both mainly composed of Si and O, since the EDS has lower sensitivity. Therefore, no useful data can be obtained to assist engineers to analyze the root cause of the defects. Even combined with the result of the step by step check, it still cannot lead to a correct conclusion.

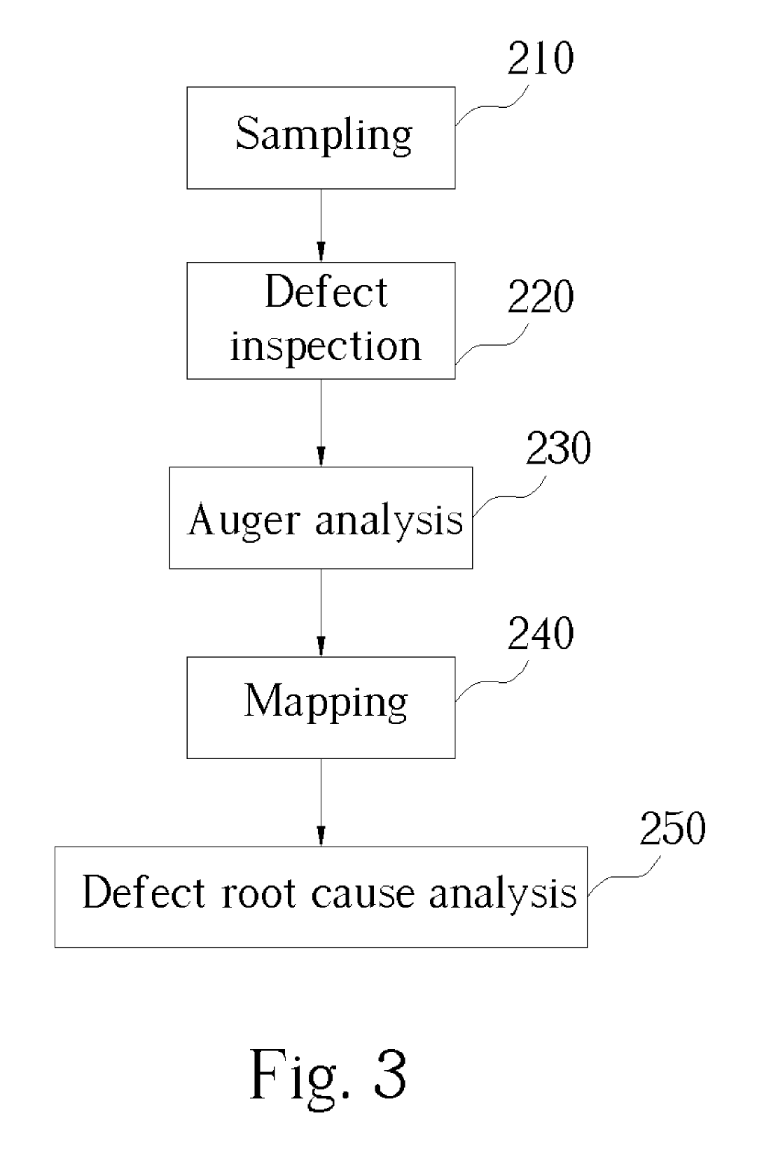

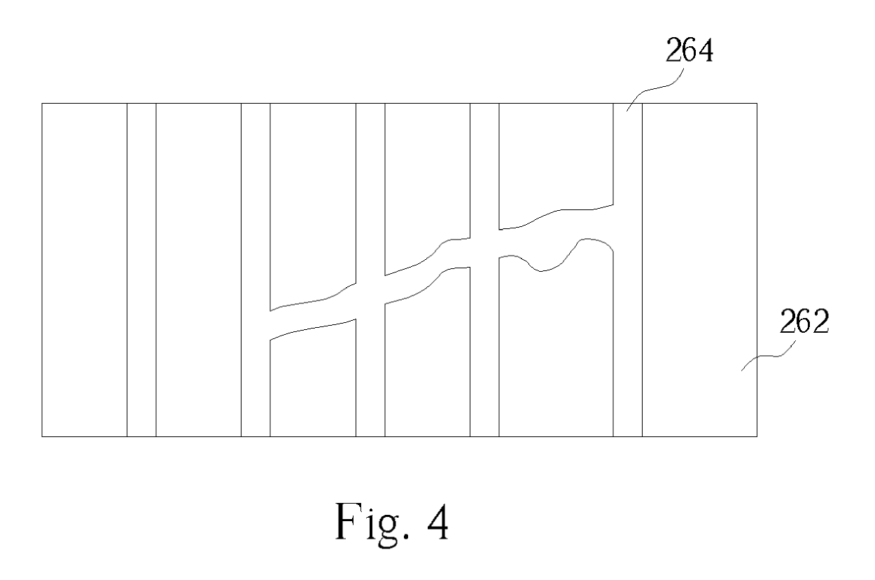

Please refer to FIG. 3, which is a schematic diagram of a method of defect root cause analysis according to a first embodiment of the present invention. As shown in FIG. 3, when some excursion cases are found after the sampling 210 and the defect inspection 220, the test sample with the excursion case will be used to perform an auger analysis 230 (assuming that the defects are located on the surface and are smaller than 0.2 μm) directly without sampling again. For those occasional excursion cases, it can improve the accuracy of sampling. In comparison with the prior art method, which needs some new test samples, it is very possible that no defect is found in new test samples, leading to a waste of time and effort. According to a result of the auger analysis 230, a mapping analysis 240 is performed. Please refer to FIG. 4, which is a schematic diagram of a chemical state distribution in a result of the mapping analysis 240. As shown in FIG. 4, the silicon oxide layer 262 and the tungsten conductive line 264 can be distinguished clearly. According to the distribution of the silicon oxide layer 262 and the tungsten conductive line 264, the root cause of the defects can be suspected to the polymer residue in a previous etching process while the defects occur in a next process indeed. Thus, the process parameters in the etching process can be tuned to reduce the polymer residue for solving this defect problem.

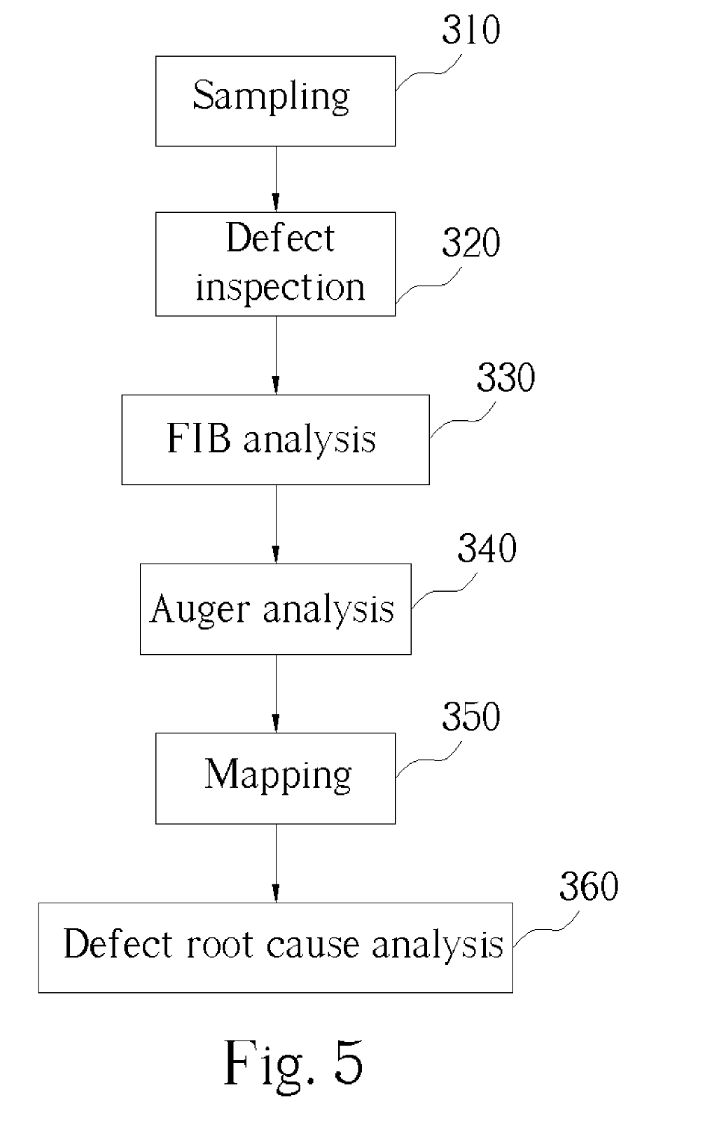

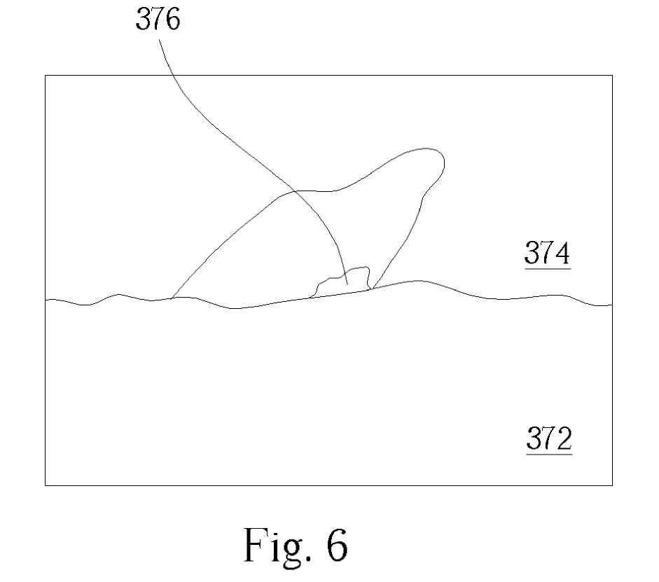

Next, a deposition process is illustrated for describing a case which has defects located in the underlayer of the test sample. Please refer to FIG. 5, which is a schematic diagram of the method of defect root cause analysis according to a second embodiment of the present invention. Taking a TiN deposition process as an example, it is supposed that some defects are found in the underlayer of a test sample during the defect inspection 320. According to the conventional method, it will trace the previous process step by step and find the defects are generated in the deposition process. The EDS analysis will only show that the defects are formed by Ti and N, which are similar to those in the background. Thus, no conclusion can be made. As shown in FIG. 5, according to the method of the present invention, if the defects are found by the SEM in the defect inspection 320, the FIB analysis 330 is performed to cut the test sample. Then, an auger analysis 340 is performed in the same manner to analyze the cross-section on which the defects are located. After that, a mapping of the state distribution can be formed and a mapping analysis 350 is then performed. Please refer to FIG. 6, which is a schematic diagram of a mapping analysis that shows the chemical state distribution in the cross-section of the test sample. As shown in FIG. 6, there are a few phosphorous particles 376 between a silicon layer 372 and a TiN layer 374. Thus, the root cause of the defects is judged as the uncleanness in the prelayer surface. By some proper adjustment, such as tuning the process parameters of a previous cleaning process or etching process, to reduce the phosphorous particles, the problem of the defects can be solved.

In contrast to the prior art, the method of defect root cause analysis of the present invention utilizes the focus ion beams (FIB) and the chemical state analysis to perform a mapping analysis, judging the root cause of the defects according to the result of the mapping analysis. Thus, the required time of the defect root cause analysis can be reduced and the accuracy can be improved. In other words, a better margin can be found in a relative short time. In addition, the present invention also provides different methods of chemical state analysis according to different defect types, leading to improvement in the accuracy and the sensitivity of the mapping analysis. The process parameters can be tuned properly and quickly to reduce the excursion case generation, improving the stability and the reliability of products.

Those skilled in the art will readily observe that numerous modifications and alterations of the device may be made while retaining the teaching of the invention. Accordingly, the above disclosure should be construed as limited only by the metes and bounds of the appended claims.

1. A method of defect root cause analysis comprising following steps:
providing a sample which comprises a plurality of defects;
performing a defect inspection to detect sizes and locations of the plurality of defects;
performing a chemical state analysis of the sample;
performing a mapping analysis according to a result of the chemical state analysis; and
analyzing the root cause of the defects according to a result of the mapping analysis.

2. The method of claim 1 further comprising performing a defect classification after finishing the defect inspection for judging a defect type of the defects and performing a corresponding chemical state analysis according to the defect type of the defects.

3. The method of claim 1 wherein an auger analysis is performed in the chemical state analysis when the defects are smaller than 0.2 μm or are not single phase particles.

4. The method of claim 3 wherein the auger analysis utilized a scanning auger microscopy (SAM) or an auger electron spectroscopy (AES) to perform the chemical state analysis of the sample.

5. The method of claim 1 wherein an energy dispersive spectrometer (EDS) is utilized to detect in the chemical state analysis when the defects are equal to or larger than 0.2 μm, single phase, or thick particles.

6. The method of claim 1 wherein the chemical state analysis comprises a point scan analysis, delayer analysis, and depth profile analysis.

7. A method of defect root cause analysis comprising following steps:
providing a sample with a plurality of defects;
performing a voltage contrast to identify locations of the defects;
cutting the sample with a focus ion beam (FIB) to expose a cross-section of the sample;
utilizing auger electrons to perform a chemical state analysis of the cross-section of the sample;
performing a mapping analysis according to a result of the chemical state analysis; and
judging a root cause of the defect generation according to a result of the mapping analysis.

8. The method of the claim 7 wherein the method utilizes a scanning auger microscopy (SAM) or an auger electron spectroscopy (AES) to perform a chemical state analysis of the cross-section of the sample.

9. The method of claim 7 wherein the chemical state analysis comprises a point scan analysis.
